(19) United States
(12) Patent Application Publication
(10) Pub. No.: US 2018/0180138 A1
(43) Pub. Date: Jun. 28, 2018

(54) TRANSMISSION

(71) Applicants: AISIN AI CO., LTD., Nishio-shi, Aichi (JP); TOYOTA JIDOSHA KABUSHIKI KAISHA, Toyota-shi, Aichi (JP)

(72) Inventors: Daisuke SAITO, Okazaki-shi, Aichi (JP); Masanori SUNAGA, Anjo-shi, Aichi (JP); Shigeki HAYASHI, Toyoake-shi, Aichi (JP); Masao ETOH, Miyoshi-shi, Aichi (JP); Koji NAITO, Nagoya-shi, Aichi (JP); Takayuki TANAKA, Nagoya-shi, Aichi (JP)

(73) Assignees: AISIN AI CO., LTD., Nishio-shi, Aichi (JP); TOYOTA JIDOSHA KABUSHIKI KAISHA, Toyota-shi, Aichi (JP)

(21) Appl. No.: 15/738,367

(22) PCT Filed: Jul. 27, 2016
(86) PCT No.: PCT/JP2016/072081

§ 371 Date: Dec. 20, 2017

(30) Foreign Application Priority Data
Nov. 19, 2015 (JP) 2015-227011

(51) Int. Cl. F16H 3/089; F16C 19/54

(52) U.S. Cl. CPC F16H 3/089; F16H 2003/0822; F16C 2326/06; F16C 19/54

(57) ABSTRACT

According to one embodiment, for example, a second support part of a first gear and a second surface of a roller of a roller bearing contact with each other to limit movement of the first gear to a first direction, and a first support part of a thrust bearing and a first surface of the roller contact with each other to limit movement of the roller bearing to the first direction.

### CROSS-REFERENCE TO RELATED APPLICATIONS

This application is national stage application of International Application No. PCT/JP2016/072081, filed Jul. 27, 2016, which designates the United States, incorporated herein by reference, and which is based upon and claims the benefit of priority from Japanese Patent Application No. 2015-227011, filed Nov. 19, 2015, the entire contents of which are incorporated herein by reference.

### TECHNICAL FIELD

The present invention relates to a transmission.

### BACKGROUND ART

Conventionally, there has been known a transmission that includes a shaft and a gear rotating around the shaft (Patent Document 1). In the transmission of Patent Document 1, the gear is supported to be rotatable through a radial roller bearing by the shaft.

### CITATION LIST

### Patent Literature

Patent Document 1: Japanese Patent Application Laid-open No. 2014-145383

### SUMMARY OF INVENTION

### Problem to be Solved by the Invention

In such kind of transmission, it is useful to obtain a new configuration with less inconvenience, for example, a configuration that can reduce more wear or can be compactly formed.

An object of the present invention is, for example, to obtain a transmission that has a new configuration with less inconvenience.

### Means for Solving Problem

A transmission according to the present invention includes, for example: a shaft that is rotatable around a first rotation center; a first gear that is rotatable around the first rotation center around the shaft; a roller bearing that includes a roller supported to be rotatable around a second rotation center parallel to the first rotation center between the first gear and the shaft, and that supports the first gear to be relatively rotatable with the shaft; and a thrust bearing that includes a first support part disposed in a first direction along an axis direction of the second rotation center and facing a first surface directed to the first direction of the roller, wherein the first gear includes a second support part disposed in a second direction of the roller bearing opposite to the first direction and facing a second surface directed to the second direction of the roller, the second support part and the second surface contact with each other to limit movement of the first gear to the first direction, and the first support part and the first surface contact with each other to limit movement of the roller bearing to the first direction.

According to the present invention, a slide position between the first surface of the roller and the first support part and a slide position between the second surface of the roller and the second support part easily come close to the first rotation center, and in addition, a diameter of the roller is relatively small. Thus, a relative slide speed between the first surface of the roller and the first support part can be lowered, and a relative slide speed between the second surface of the roller and the second support part can be lowered. Thus, according to the present invention, for example, wear of sliding components caused by relative rotation of the first gear and the shaft can be easily reduced.

The above-mentioned transmission includes, for example, a second gear that is disposed in the first direction of the first support part to be rotatable integrally with the shaft, and supports the first support part in the axis direction. With this configuration, the second gear provided to be rotatable integrally with the shaft can be used for supporting the roller and the first support part, that is, the first gear in an axis direction. Thus, the configuration can be more simplified as compared with a case where, for example, another member different from the second gear is provided for supporting the first gear in the axis direction.

The above-mentioned transmission includes, for example, a first member that is disposed in the second direction of the first gear to be rotatable integrally with the shaft, wherein the second support part includes a third surface that faces the first member, and the third surface and the first member contact with each other to limit movement of the first gear to the second direction. With this configuration, the second support part used for limiting movement of the first gear to the first direction, in other words, supporting from the first direction can be used for limiting movement of the first gear to the second direction, in other words, supporting from the second direction. Thus, the configuration can be more simplified, as compared with a case where, for example, another member/part different from the second support part is provided for supporting the first gear from the second direction.

In the above-mentioned transmission, for example, the third surface is provided over between more outside in a radial direction than a first end of the roller and more inside in the radial direction than the first end, the first end being positioned on outside of the second rotation center in the radial direction. With this configuration, for example, the third surface can come into contact with the first member on a relatively wide area. Thus, surface pressure is easily reduced, and therefore, wear between the third surface and the first member generated by relative rotation of the first gear and the first member can be reduced.

### BRIEF DESCRIPTION OF DRAWINGS

FIG. 1 is an exemplary and schematic view illustrating a configuration of a transmission according to an embodiment;

FIG. 2 is an exemplary and schematic view illustrating the disposition of a plurality of shafts that are seen from an axis direction of the transmission according to the embodiment; and

FIG. 3 is an exemplary and schematic sectional view of a part of the transmission according to the embodiment.

### DESCRIPTION OF EMBODIMENT

An exemplary embodiment of the present invention will now be described. The configuration of the embodiment described below, and actions, results, and effects brought about by the configuration have been presented by way of example. The present invention can be achieved by a configuration other than the configuration disclosed in the following embodiment. According to the present invention, out of the various kinds of effects obtained by the configuration, at least one effect can be obtained.

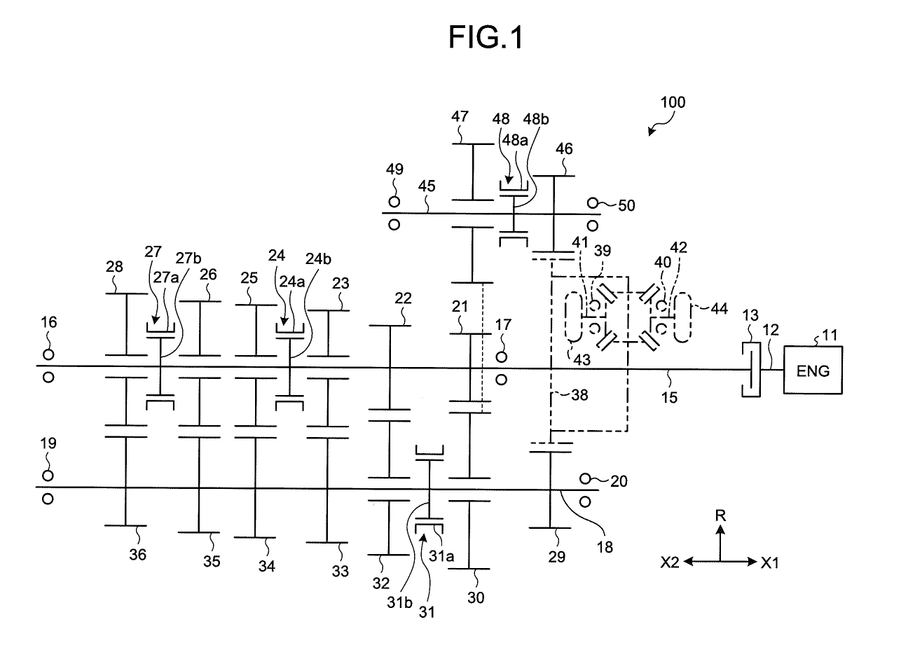

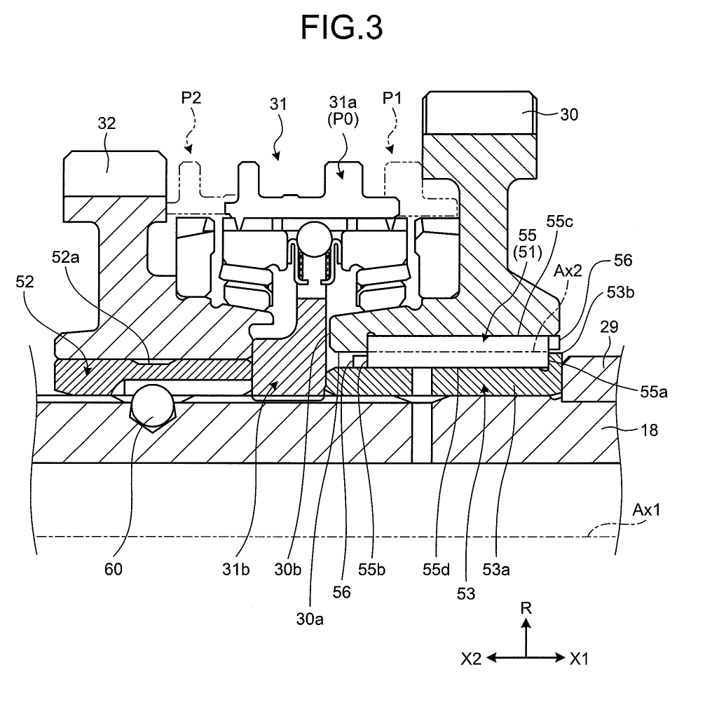

In the embodiment, an axis direction, a radial direction, and a circumferential direction are defined for a plurality of shafts. The shafts are parallel in the axis direction. Hereinafter, for convenience, an engine 11 side (right side) in FIGS. 1 and 3, a side (left side) opposite to the engine 11 in FIGS. 1 and 3, and the radial direction are referred to as X1 direction, X2 direction, and R direction, respectively. X1 direction is one example of a first direction, and X2 direction is one example of a second direction. The size of each gear in FIG. 1 does not represent the size of actual gears. In the drawings, a dash line between two gears 30 and 47 indicates that two gears 30 and 47 are engaged with each other.

As illustrated in FIG. 1, a transmission 100 is disposed between the engine (ENG) 11 that is on an input side and wheels 43 and 44 that are on an output side. The transmission 100 includes, for example, six speed change stages (first speed to sixth speed) for forward movement of a vehicle and one speed change stage (reverse) for backward movement of the vehicle. The transmission 100 can adjust power (torque) of the engine 11 depending on a traveling situation by operation of an unillustrated shift lever, and can transmit the adjusted power of the engine 11 to the wheels 43 and 44.

The transmission 100 includes, for example, an input shaft 15, and an output shaft 18, and an idler shaft 45. The input shaft 15 is, in an unillustrated casing of the transmission 100, supported so as to be rotatable via bearings 16 and 17. In addition, the output shaft 18 is supported so as to be rotatable via bearings 19 and 20 in the casing, and the idler shaft 45 is supported so as to be rotatable via bearings 49 and 50 in the casing.

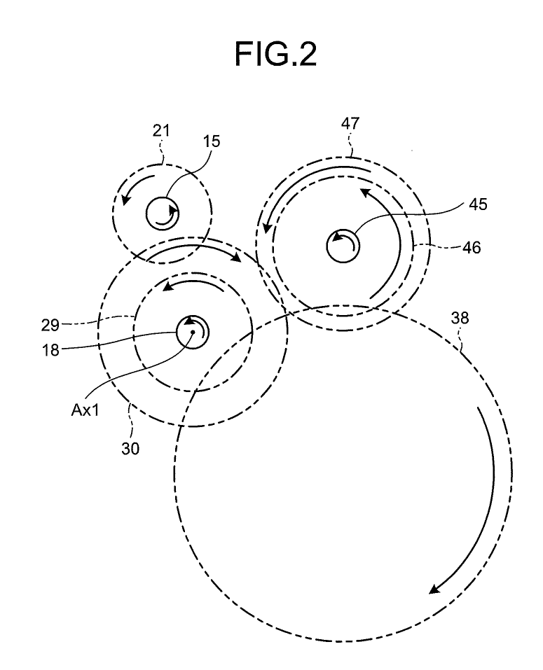

As illustrated in FIGS. 1 and 2, the output shaft 18 and the idler shaft 45 are disposed parallel to the input shaft 15 and are disposed at an interval around the input shaft 15. In the embodiment, for example, the input shaft 15 and the idler shaft 45 are disposed separately from each other in a horizontal direction in FIG. 2, and the output shaft 18 is, between the input shaft 15 and idler shaft 45, disposed downward than the input shaft 15 and idler shaft 45 in FIG. 2. However, the present invention is not limited to this disposition of the shafts 15, 18, and 45.

As illustrated in FIG. 1, the input shaft 15 is connected to an output axis 12 of the engine 11 via a clutch 13. The clutch 13 switches between a connected state and an interrupted state between the engine 11 and the input shaft 15. In addition, the output shaft 18 and the idler shaft 45 are connected to drive shafts 41 and 42 of the wheels 43 and 44 via a differential casing 38. The drive shafts 41 and 42 are supported so as to be rotatable by a vehicle main body via bearings 39 and 40.

Between the bearings 16 and 17 of the input shaft 15, a plurality of driving gears 21, 22, 23, 25, 26, and 28 are provided. In the embodiment, for example, the driving gear 21 at a first speed change stage, the driving gear 22 at a second speed change stage, the driving gear 23 at a third speed change stage, the driving gear 25 at a fourth speed change stage, the driving gear 26 at a fifth speed change stage, and the driving gear 28 at a sixth speed change stage are disposed from the engine 11 side to the X2 direction.

In the embodiment, the driving gears 21 and 22 are provided so as to be rotatable integrally with the input shaft 15. The driving gears 23, 25, 26, and 28 are provided so as to be relatively rotatable with the input shaft 15. The driving gears 21 and 22 are integrated with the input shaft 15 by, for example, spline coupling and press fitting. The driving gears 23, 25, 26, and 28 are supported so as to be relatively rotatable with the input shaft 15 via, for example, bearings. The driving gears 21 and 22 can be referred to as fixed gears, and the driving gears 23, 25, 26, and 28 can be referred to as free gears, for example. When being disconnected to the input shaft 15 by first selector mechanisms 24 and 27 illustrated in FIG. 1, the driving gears 23, 25, 26, and 28 are idly rotatable with respect to the input shaft 15.

Between the bearings 19 and 20 of the output shaft 18, a plurality of driven gears 30, 32, 33, 34, 35, and 36, and a final gear 29 are provided. In the embodiment, for example, the final gear 29, the driven gear 30 at the first speed change stage, the driven gear 32 at the second speed change stage, the driven gear 33 at the third speed change stage, the driven gear 34 at the fourth speed change stage, the driven gear 35 at the fifth speed change stage, and the driven gear 36 at the sixth speed change stage are disposed from the engine 11 side to the X2 direction. The driven gears 30, 32, 33, 34, 35, and 36 are engaged with the driving gears 21, 22, 23, 25, 26, and 28, respectively. The final gear 29 is engaged with the differential casing 38.

In the embodiment, the driven gears 30 and 32 are provided so as to be relatively rotatable with the output shaft 18. The driven gears 33 to 36 and the final gear 29 are provided so as to be rotatable integrally with the output shaft 18. The driven gears 33 to 36 and the final gear 29 are integrated with the output shaft 18 by, for example, spline coupling and press fitting. As illustrated in FIG. 3, the driven gear 30 is supported so as to be relatively rotatable with the output shaft 18 via a roller bearing 51 as a bearing, and the driven gear 32 is supported so as to be relatively rotatable with the output shaft 18 via a metal collar 52. The driven gears 33 to 36 and the final gear 29 can be referred to as fixed gears, and the driven gears 30 and 32 can be referred to as free gears, for example. When being disconnected to the output shaft 18 by a second selector mechanism 31 illustrated in FIGS. 1 and 3, the driven gears 30 and 32 are idly rotatable with respect to the output shaft 18.

The second selector mechanism 31 selectively switches between a connected state and an interrupted state between the output shaft 18 and the driven gears 30 and 32. The second selector mechanism 31 includes a movable part 31a and a fixed part 31b. As illustrated in FIG. 3, the fixed part 31b is connected to the output shaft 18 by, for example, spline coupling, and rotates integrally with the output shaft 18. The fixed part 31b can be referred to as a clutch hub, for example. The movable part 31a rotates integrally with the fixed part 31b, and is provided so as to be movable with respect to the fixed part 31b in the axis direction of the output shaft 18. The movable part 31a can be referred to as a sleeve, for example.

The second selector mechanism 31 is disposed between the driven gears 30 and 32. The movable part 31a is movable among a first connected position P1 where the movable part 31a is connected to the driven gear 30, a second connected position P2 where the movable part 31a is connected to the driven gear 32, and a neutral position P0 between the first connected position P1 and the second connected position P2. The movable part 31a is selectively positioned at any one of the first connected position P1 with the driven gear 30, the second connected position P2 with the driven gear 32, and the neutral position P0 by an unillustrated actuator and moving mechanism. When the movable part 31a is positioned at the first connected position P1 with the driven gear 30, the output shaft 18 and the driven gear 30 are integrally rotatable. In this case, there is formed a transmission path for rotation at the first speed change stage from the input shaft 15 to the driving gear 21, the driven gear 30, the output shaft 18, the final gear 29, the differential casing 38, and the drive shafts 41 and 42 illustrated in FIG. 1.

When the movable part 31a is disposed at the second connected position P2 with the driven gear 32, the output shaft 18 and the driven gear 32 are integrally rotatable. In this case, there is formed a transmission path for rotation at the second speed change stage from the input shaft 15 to the driving gear 22, the driven gear 32, the output shaft 18, the final gear 29, the differential casing 38, and the drive shafts 41 and 42 illustrated in FIG. 1. When the movable part 31a is positioned at the neutral position P0 and at a connected position with the other driven gear, the driven gears 30 and 32 are idly rotatable with respect to the output shaft 18.

As illustrated in FIG. 1, the first selector mechanisms 24 and 27 selectively switch between a connected state and an interrupted state between the input shaft 15 and the driving gears 23, 25, 26, and 28. The first selector mechanisms 24 and 27 include movable parts 24a and 27a and fixed parts 24b and 27b, respectively. The fixed parts 24b and 27b are connected to the input shaft 15 by, for example, spline coupling, and rotate integrally with the input shaft 15. The fixed parts 24b and 27b can be referred to as clutch hubs, for example. The movable parts 24a and 27a rotate integrally with the fixed parts 24b and 27b, respectively. The movable parts 24a and 27a are provided so as to be movable with respect to the fixed parts 24b and 27b in the axis direction of the input shaft 15. The movable parts 24a and 27a can be referred to as sleeves, for example.

The first selector mechanism 24 is disposed between the driving gears 23 and 25. The movable part 24a is movable among a first connected position where the movable part 24a is connected to the driving gear 23, a second connected position where the movable part 24a is connected to the driving gear 25, and a neutral position between the first connected position and the second connected position. The movable part 24a is selectively positioned at any one of the first connected position with the driving gear 23, the second connected position with the driving gear 25, and the neutral position by an unillustrated actuator and moving mechanism. When the movable part 24a is positioned at the first connected position with the driving gear 23, the input shaft 15 and the driving gear 23 are integrally rotatable. In this case, there is formed a transmission path for rotation at the third speed change stage from the input shaft 15 to the driving gear 23, the driven gear 33, the output shaft 18, the final gear 29, the differential casing 38, and the drive shafts 41 and 42 illustrated in FIG. 1.

When the movable part 24a is disposed at the second connected position with the driving gear 25, the input shaft 15 and the driving gear 25 are integrally rotatable. In this case, there is formed a transmission path for rotation at the fourth speed change stage from the input shaft 15 to the driving gear 25, the driven gear 34, the output shaft 18, the final gear 29, the differential casing 38, and the drive shafts 41 and 42 illustrated in FIG. 1. When the movable part 24a is positioned at the neutral position and a connected position with the other driven gear, the driving gears 23 and 25 are idly rotatable with respect to the input shaft 15.

The first selector mechanism 27 is disposed between the driving gears 26 and 28. The movable part 27a is movable among a first connected position where the movable part 27a is connected to the driving gear 26, a second connected position where the movable part 27a is connected to the driving gear 28, and a neutral position between the first connected position and the second connected position. The movable part 27a is selectively positioned at any one of the first connected position with the driving gear 26, the second connected position with the driving gear 28, and the neutral position by an unillustrated actuator and moving mechanism. When the movable part 27a is positioned at the first connected position with the driving gear 26, the input shaft 15 and the driving gear 26 are integrally rotatable. In this case, there is formed a transmission path for rotation at the fifth speed change stage from the input shaft 15 to the driving gear 26, the driven gear 35, the output shaft 18, the final gear 29, the differential casing 38, and the drive shafts 41 and 42 illustrated in FIG. 1.

When the movable part 27a is positioned at the second connected position with the driving gear 28, the input shaft 15 and the driving gear 28 are integrally rotatable. In this case, there is formed a transmission path for rotation at the sixth speed change stage from the input shaft 15 to the driving gear 28, the driven gear 36, the output shaft 18, the final gear 29, the differential casing 38, and the drive shafts 41 and 42 illustrated in FIG. 1. When the movable part 27a is positioned at the neutral position and a connected position with the other driving gear, the driving gears 26 and 28 are idly rotatable with respect to the input shaft 15.

As illustrated in FIG. 1, the idler gear 47 and a final gear 46 are provided between the bearings 49 and 50 of the idler shaft 45. In the embodiment, for example, the final gear 46 and the idler gear 47 at the reverse speed change stage are disposed from the engine 11 side to the X2 direction. As illustrated in FIGS. 1 and 2, the final gear 46 is engaged with the differential casing 38, and the idler gear 47 is engaged with the driven gear 30.

In the embodiment, the final gear 46 is provided so as to be rotatable integrally with the idler shaft 45, and the idler gear 47 is provided so as to be relatively rotatable with the idler shaft 45. The final gear 46 is integrated with the idler shaft 45 by, for example, spline coupling and press fitting. The idler gear 47 is supported so as to be relatively rotatable with respect to the idler shaft 45 via, for example, a bearing. In the embodiment, when being disconnected to the idler shaft 45 by a third selector mechanism 48 illustrated in FIG. 1, the idler gear 47 is idly rotatable with respect to the idler shaft 45.

The third selector mechanism 48 selectively switches between a connected state and an interrupted state between the idler shaft 45 and the idler gear 47. The third selector mechanism 48 includes a movable part 48a and a fixed part 48b. The fixed part 48b is connected to the idler shaft 45 by, for example, spline coupling, and rotates integrally with the idler shaft 45. The fixed part 48b can be referred to as a clutch hub, for example. The movable part 48a rotates integrally with the fixed part 48b, and is provided so as to be movable with respect to the fixed part 48b in the axis direction of the idler shaft 45. The movable part 48a can be referred to as a sleeve, for example.

The third selector mechanism 48 is disposed between the final gear 46 and the idler gear 47. The movable part 48a is movable between a connected position where the movable part 48a is connected to the idler gear 47 and a separated position where the movable part 48a is separated from the idler gear 47. The movable part 48a is selectively positioned at any one of the connected position with the idler gear 47 and the separated position by an unillustrated actuator and moving mechanism. When the movable part 48a is positioned at the connected position with the idler gear 47, the idler shaft 45 and the idler gear 47 are integrally movable. In this case, there is formed a transmission path for rotation at the reverse speed change stage from the input shaft 15 to the driving gear 21, the driven gear 30, the idler gear 47, the idler shaft 45, the final gear 46, the differential casing 38, and the drive shafts 41 and 42 illustrated in FIGS. 1 and 2. When the movable part 48a is positioned at the separated position, the idler gear 47 is idly rotatable with respect to the idler shaft 45.

The roller bearing 51 illustrated in FIG. 3 includes, for example, a plurality of rollers 55 and a holder 56. The rollers 55 are disposed at an interval from each other along a circumferential direction of the output shaft 18. Each of the rollers 55 extends thin and long in a needle shape along the axis direction of the output shaft 18, and is supported by the holder 56 so as to be rotatable around an axial center Ax2 parallel to an axial center Ax1 of the output shaft 18. In addition, the rollers 55 are provided so as to be rollable on the inner peripheral surface of the driven gear 30. By rolling of the rollers 55, the roller bearing 51 can support the driven gear 30 so as to be relatively rotatable with the output shaft 18. In the embodiment, the driven gear 30 is one example of a first gear, and the output shaft 18 is one example of a shaft. The axial center Ax1 is one example of a first rotation center, and the axial center Ax2 is one example of a second rotation center.

The driven gear 30 includes a second support part 30a, for example, as a projection. As illustrated in FIG. 3, the second support part 30a projects from an end of the driven gear 30 in the X2 direction to the inside in the radial direction, in other words, to the axial center Ax1 side. The second support part 30a faces each surface 55b of the rollers 55 directed to the X2 direction. The second support part 30a can be formed in an annular shape along the circumferential direction of the output shaft 18. A plurality of the second support parts 30a may be provided at an interval from each other along the circumferential direction of the output shaft 18 so as to face each of the surfaces 55b of the rollers 55. In the embodiment, the surface 55b is one example of the second surface.

The second support parts 30a includes a surface 30b directed to the X2 direction, in other words, to a side opposite to the roller bearing 51. The surface 30b faces the fixed part 31b (clutch hub) of the second selector mechanism 31. In the embodiment, the surface 30b is provided over more outside in the radial direction than an end 55c of the roller 55, the end 55c being on the outside in the radial direction, and more inside in the radial direction than the end 55c. In the embodiment, the end 55c is one example of a first end, the surface 30b is one example of a third surface, and a fixed part 31b is one example of a first member.

In the embodiment, external teeth of all respective gears provided to the input shaft 15, the output shaft 18, and the idler shaft 45 are formed of helical teeth (helical gear). Therefore, by engaging the driving gear 21 with the driven gear 30, a thrust force is generated in the driven gear 30, and thus the driven gear 30 may move with respect to the output shaft 18 in the axis direction. In the embodiment, as described above, the second support parts 30a are provided so as to face the surfaces 55b of the roller bearing 51, and the fixed part 31b is provided so as to face the surface 30b of the second support part 30a. Therefore, in the embodiment, movement of the driven gear 30 in the X1 direction is limited by contact between the second support part 30a and the surfaces 55b, and movement of the driven gear 30 in the X2 direction is limited by contact between the surface 30b and with the fixed part 31b.

As illustrated in FIG. 3, a metal collar 53 as a bearing is provided between the output shaft 18 and the roller bearing 51. The metal collar 53 includes, for example, a cylindrical part 53a and a flange 53b. The cylindrical part 53a is formed in a cylindrical shape along the circumferential direction of the output shaft 18, and supports an end 55d of each of the rollers 55, the end 55d being on the inside in the radial direction. The cylindrical part 53a can be referred to as an inner race, for example. Even when a plurality of recession/projection are provided on an outer peripheral surface of the output shaft 18 for spline coupling, the cylindrical part 53a can secure smooth rolling of the rollers 55. The cylindrical part 53a is one example of a radial bearing.

The flange 53b projects from an end part of the cylindrical part 53a in the X1 direction to the outside in the radial direction. The flange 53b faces each surface 55a of the rollers 55 directed to the X1 direction. The flange 53b can be formed in an annular shape along the circumferential direction of the output shaft 18. A plurality of the flanges 53b may be provided at an interval from each other along the circumferential direction of the output shaft 18 so as to face each of the surfaces 55a of the rollers 55. In the embodiment, the metal collar 53 (flange 53b) is one example of a thrust bearing, the flange 53b is one example of a first support part, and the surfaces 55a are one example of a first surface.

In addition, the metal collar 53 is interposed between the fixed part 31b and the final gear 29. In other words, movement of the metal collar 53 to the axis direction against the output shaft 18 is limited by the fixed part 31b and the final gear 29. In the embodiment, the final gear 29 is disposed overlapped with at least a part of the flange 53b in the axis direction, and supports the flange 53b in the axis direction. Therefore, according to the embodiment, movement of the roller bearing 51 to the X1 direction is limited by contact between the flange 53b and the surfaces 55a, and inclination and deformation of the flange 53b in the X1 direction can be reduced by contact between the flange 53b and the final gear 29. In the embodiment, the final gear 29 is one example of a second gear.

In the embodiment, examples of a thrust bearing is configured by the metal collar 53 including the cylindrical part 53a and the flange 53b, but the thrust bearing is not limited to this. The thrust bearing may be configured by a ring-shaped washer receiving a thrust power of the roller bearing 51. In addition, the cylindrical part 53a and the flange 53b may be configured by separately independent members.

As illustrated in FIG. 3, the metal collar 52 is, for example, formed in a cylindrical shape along the circumferential direction of the output shaft 18. The metal collar 52 is connected to the output shaft 18 so as to be relatively non-rotatable via a ball 60. In other words, the metal collar 52 rotates integrally with the output shaft 18. A recession 52a capable of housing a lubricant is provided on a surface outside the metal collar 52 in the radial direction. The metal collar 52 is one example of a radial bearing.

As illustrated in FIG. 2, in the embodiment, when the above-mentioned transmission path for rotation at the reverse speed change stage is formed, for example, the input shaft 15, the driving gear 21, the idler gear 47, the idler shaft 45, and the final gear 46 rotate in the first rotation direction, in other words, counterclockwise in FIG. 2, and the driven gear 30 and the differential casing 38 rotate in the second rotation direction, in other words, clockwise in FIG. 2. In addition, the final gear 29 and the output shaft 18 rotate in the first rotation direction because the differential casing 38 and the final gear 29 are engaged with each other. Thus, relative rotation is generated between the output shaft 18 and the driven gear 30. Granted that movement of the driven gear 30 to the X1 direction is limited by contact between the driven gear 30 and the thrust bearing (washer), relative rotation between the output shaft 18 and the driven gear 30 may cause the driven gear 30 and the thrust bearing to be worn comparatively large. In this respect, according to the embodiment, movement of the driven gear 30 to the X1 direction is limited by the flange 53b, the second support part 30a, and the surfaces 55a and 55b of the roller bearing 51, thereby easily reducing wear between the flange 53b and the surface 55a and between the second support part 30a and the surface 55b owing to relative rotation of the output shaft 18 and the driven gear 30.

As described above, in the embodiment, for example, the transmission 100 includes: the output shaft 18 (shaft) that is rotatable around the axial center Ax1 (first rotation center); the driven gear 30 (first gear) at the first speed change stage that is rotatable around the axial center Ax1 around the output shaft 18; the roller bearing 51 that includes the rollers 55 supported so as to be rotatable around the axial center Ax2 (second rotation center) parallel to the axial center Ax1 between the driven gear 30 and the output shaft 18, and that supports the driven gear 30 so as to be relatively rotatable with the output shaft 18; and the metal collar 53 (thrust bearing) that includes the flange 53b (first support part) disposed in the X1 direction (first direction) of the roller bearing 51 along the axis direction of the axial center Ax2 and facing the surface 55a (first surface) directed to the X1 direction of the rollers 55. The driven gear 30 includes the second support part 30a that is disposed in the X2 direction (second direction) of the roller bearing 51 opposite to the X1 direction and that faces the surface 55b (second surface) directed to the X2 direction of the rollers 55. In the embodiment, the second support part 30a and the surface 55b contact with each other to limit movement of the driven gear 30 to the X1 direction, and the flange 53b and the surface 55a contact with each other to limit movement of the roller bearing 51 to the X1 direction.

According to the embodiment, a slide position between the surface 55a of each roller 55 and the flange 53b and a slide position between the surface 55b of the roller 55 and the second support part 30a easily come close to the axial center Ax1, and in addition, a diameter of the roller 55 is relatively small. Thus, for example, a relative slide speed between the surface 55a of the roller 55 and the flange 53b and a relative slide speed between the surface 55b of the roller 55 and the second support part 30a can be more reduced. According to the embodiment, for example, wear of sliding components caused by relative rotation of the driven gear 30 and the output shaft 18 can be easily reduced.

In the embodiment, for example, the transmission 100 includes the final gear 29 (second gear) that is disposed in the X1 direction of the flange 53b, is provided so as to be rotatable integrally with the output shaft 18, and supports the flange 53b in the axis direction. Therefore, according to the embodiment, for example, the final gear 29 provided so as to be rotatable integrally with the output shaft 18 can be used for supporting the rollers 55 and the flange 53b, that is, the driven gear 30 in the axis direction. Thus, for example, the configuration can be more simplified as compared with a case where another member different from the final gear 29 is provided for supporting the driven gear 30 in the axis direction.

In the embodiment, for example, the transmission 100 includes the fixed part 31b (first member) that is disposed in the X2 direction of the driven gear 30 and is provided so as to be rotatable integrally with the output shaft 18. Herein, the second support part 30a includes the surface 30b (third surface) facing the fixed part 31b. In the embodiment, the surface 30b and the fixed part 31b contact with each other to limit movement of the driven gear 30 to the X2 direction. Therefore, according to the embodiment, for example, the second support part 30a used for limiting movement of the driven gear 30 to the X1 direction, in other words, supporting from the X1 direction can be used for limiting the movement of the driven gear 30 to the X2 direction, in other words, supporting from the X2 direction. Thus, for example, the configuration can be more simplified as compared with a case where another member/part different from the second support part 30a is used for supporting the driven gear 30 in the X2 direction.

In the embodiment, for example, the surface 30b (third surface) is provided over between more outside in the radial direction than the end 55c (first end) of the roller 55 and more inside in the radial direction than the end part 55c. Herein, the end 55c is positioned on the outside of the axial center Ax2 in the radial direction. Therefore, according to the embodiment, for example, the surface 30b can come into contact with the fixed part 31b (first member) on a relatively wide area. Thus, surface pressure is easily reduced, and therefore, wear between the surface 30b and the fixed part 31b generated by relative rotation of the driven gear 30 and the fixed part 31b can be reduced.

While the embodiment of the present invention has been described, the embodiment has been presented by way of example only, and is not intended to limit the scope of the inventions. The embodiment can be implemented in a variety of other forms, and various omissions, substitutions, combinations, and changes can be made without departing from the spirit of the inventions. The embodiment is included in the scope and spirit of the inventions, and is included in the inventions disclosed in the accompanying claims and their equivalents. The present inventions can be achieved by a configuration other than the configuration disclosed in the embodiment, and can obtain various effects (including derivative effects) obtained by a basic configuration (technical features). Specifications (configurations, kinds, directions, shapes, size, length width, thickness, height, the number, arrangement, position, materials, and the like) for each component can be modified and implemented as appropriate.

### EXPLANATIONS OF LETTERS OR NUMERALS

18 OUTPUT SHAFT (SHAFT)
29 FINAL GEAR (SECOND GEAR)
30 DRIVEN GEAR (FIRST GEAR)
30a SECOND SUPPORT PART
30b SURFACE (THIRD SURFACE)
31b FIXED PART (FIRST MEMBER)
51 ROLLER BEARING
53 METAL COLLAR (THRUST BEARING)
53b FLANGE (FIRST SUPPORT PART)
55 ROLLER
55a SURFACE (FIRST SURFACE)
55b SURFACE (SECOND SURFACE)
55c END (FIRST END)
100 TRANSMISSION
Ax1 AXIAL CENTER (FIRST ROTATION CENTER)
AX2 AXIAL CENTER (SECOND ROTATION CENTER)
R RADIAL DIRECTION
X1 FIRST DIRECTION
X2 SECOND DIRECTION

1. A transmission comprising:
a shaft that is rotatable around a first rotation center;
a first gear that is rotatable around the first rotation center around the shaft;
a roller bearing that comprises a roller supported to be rotatable around a second rotation center parallel to the first rotation center between the first gear and the shaft, and that supports the first gear to be relatively rotatable with the shaft; and
a thrust bearing that includes a first support part disposed in a first direction along an axis direction of the second rotation center and facing a first surface directed to the first direction of the roller, wherein
the first gear includes a second support part disposed in a second direction of the roller bearing opposite to the first direction and facing a second surface directed to the second direction of the roller,
the second support part and the second surface contact with each other to limit movement of the first gear to the first direction, and
the first support part and the first surface contact with each other to limit movement of the roller bearing to the first direction.

2. The transmission according to claim 1, further comprising:
a second gear that is disposed in the first direction of the first support part to be rotatable integrally with the shaft, and supports the first support part in the axis direction.

3. The transmission according to claim 1, further comprising:
a first member that is disposed in the second direction of the first gear to be rotatable integrally with the shaft, wherein
the second support part includes a third surface that faces the first member, and
the third surface and the first member contact with each other to limit movement of the first gear to the second direction.

4. The transmission according to claim 3, wherein the third surface is provided over between more outside in a radial direction than a first end of the roller and more inside in the radial direction than the first end, the first end being positioned on outside of the second rotation center in the radial direction.
